(19) United States
(12) Patent Application Publication
(10) Pub. No.: US 2012/0328783 A1
(43) Pub. Date: Dec. 27, 2012

(54) APPARATUS AND METHOD FOR WOOD FINISHING SHEETS

(75) Inventors: Christopher W. Smith, Logan, UT (US); David H. Murphy, Providence, UT (US)

(73) Assignee: HARRIS RESEARCH, INC., Logan, UT (US)

(21) Appl. No.: 13/532,657

(22) Filed: Jun. 25, 2012

Related U.S. Application Data
(60) Provisional application No. 61/500,533, filed on Jun. 23, 2011.

(51) Int. Cl. B65D 81/22; B05D 3/00; B05D 7/06; B65B 29/00; B05C 1/00

(52) U.S. Cl. 427/299; 206/207; 53/431; 401/261; 427/429

(57) ABSTRACT

An apparatus and method for wood finishing sheets is provided. The apparatus includes a plurality of absorbent sheets in close proximity to each other within a container, and a wood finishing composition being evenly permeated throughout the plurality of absorbent sheets. The wood finishing composition may be one of stain, colored finish, clear coat, and/or wood sealant and may further include an extender chemical. The method includes preparing wood finishing sheets, by placing a plurality of absorbent sheets in close proximity to each other in a container, adding a wood finishing composition to the plurality of absorbent sheets, enclosing within the container the sheets and the wood finishing composition using a sealing mechanism, and allowing time for the wood finishing composition to permeate the sheets.

### CROSS-REFERENCES TO RELATED APPLICATIONS

This application claims priority to U.S. Provisional Patent Application No. 61/500,553 entitled “APPARATUS AND METHOD FOR WOOD FINISHING SHEETS” and filed on Jun. 23, 2011 for Christopher W. Smith et al., which is incorporated herein by reference.

### TECHNICAL FIELD

This disclosure relates to wood finishing products and more particularly relates to wood staining, colored finishing, clear coat application and sealing wood surfaces.

### BACKGROUND

Wood finishing is the process of protecting, enhancing and enriching a wood surface. Typically the wood is first prepared by sanding or scraping the surface to remove any imperfections. Sometimes a wood conditioning agent is applied to the newly sanded surface to further prepare the wood for the application of the wood finish. For example, shellac may be applied to the surface in order to prevent subsequent coats of stain from blotching and primer may be applied to the surface to promote the adhesion of subsequent coats of finish. After the surface is prepared, stain is often applied in order to change the color of the wood. After the stain and/or colored finish has been applied, a clear coat, lacquer, varnish or other finishing composition of the desired sheen is applied to the wood surface in order to produce a hard and durable layer of protection.

Conventional systems for applying wood finish are arduous and messy and require a great deal of effort and skill The user has to repeatedly moisten a cloth with the desired wood finishing agent and then wipe the desired wood surface with the cloth. With such systems, achieving a smooth and continuous application is difficult and most surfaces are left with a streaky finish. Additionally, conventional methods require long drying times and the materials are difficult to clean up and dispose of.

### SUMMARY

From the foregoing discussion, it should be apparent that a need exists for an apparatus and method that overcome the drawbacks of conventional wood finishing products.

The present disclosure has been developed in response to the present state of the art, and in particular, in response to the problems and needs in the art that have not yet been fully solved by currently available products. Accordingly, the present disclosure provides an apparatus and method for preparing and applying a wood finishing composition that overcomes many or all of the above-discussed shortcomings in the art.

The present disclosure includes an apparatus having a plurality of absorbent sheets in close proximity to each other within a container and a wood finishing composition evenly permeated throughout the plurality of absorbent sheets. The wood finishing composition may be selected from a group consisting of stain, colored finish, clear coat, and wood sealant. The wood finishing composition may further comprise an extender chemical.

The present disclosure also includes a method for preparing wood finishing sheets which includes placing a plurality of absorbent sheets in close proximity to each other in a container. Additionally, the method includes adding a wood finishing composition to the container with the plurality of absorbent sheets and enclosing the plurality of absorbent sheets and the wood finishing composition within the container using a sealing mechanism. The wood finishing composition is then allowed time to permeate the plurality of absorbent sheets. The method may further comprise augmenting the permeation by systematically agitating the container. The present disclosure also includes a method for using wood finishing sheets which includes opening a sealing mechanism on a container, removing a wood finishing sheet from the container, orienting the wood finishing sheet in a user's hand, and wiping the wood finishing sheet along a wood surface.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

These features and advantages of the present disclosure will become more fully apparent from the following description and appended claims, or may be learned by the practice of the disclosure as set forth hereinafter.

### BRIEF DESCRIPTION OF THE DRAWINGS

In order that the advantages of the disclosure will be readily understood, a more particular description of the disclosure briefly described above will be rendered by reference to specific embodiments that are illustrated in the appended drawings. Understanding that these drawings depict only typical embodiments of the disclosure and are not therefore to be considered to be limiting of its scope, the disclosure will be described and explained with additional specificity and detail through the use of the accompanying drawings, in which:

FIG. 1 illustrates one embodiment of an apparatus used for preparing, containing, and dispensing wood finishing sheets;

FIG. 2 is a cross-sectional view depicting one embodiment of the preparation of a wood finishing sheets apparatus;

FIG. 3 illustrates another embodiment of an apparatus which is used for preparing, containing, and dispensing wood finishing sheets;

FIG. 4 illustrates one embodiment of using a wood finishing sheet;

FIG. 5 is a schematic flow chart diagram illustrating one embodiment of a method for preparing wood finishing sheets; and

FIG. 6 is a schematic flow chart diagram illustrating one embodiment of a method for using wood finishing sheets.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Furthermore, the described features, structures, or characteristics of the disclosure may be combined in any suitable manner in one or more embodiments. In the following description, numerous specific details are provided. However, one skilled in the relevant art will recognize that the disclosure may be practiced without one or more of the specific details, or with other methods, components, materials, and so forth. In other instances, well-known structures, materials, or operations are not shown or described in detail to avoid obscuring aspects of the disclosure.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

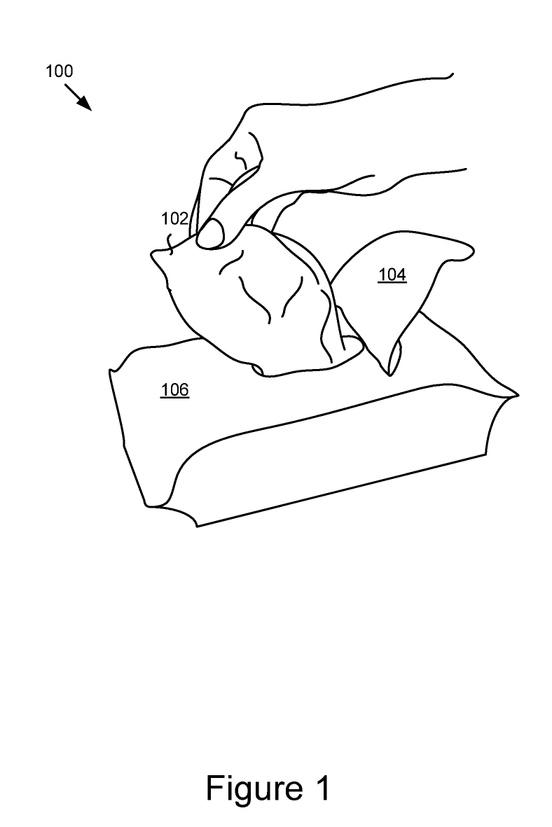

FIG. 1 depicts one embodiment of an apparatus 100 for containing and dispensing wood finishing sheets. The depicted apparatus includes a container 106 for storing the wood finishing sheets 102, and a sealing mechanism 104. A sheet may be a fiber, fabric or tissue that is capable of absorbing a liquid. In one embodiment, the size of a sheet is in the range of between about 9 square inches and 576 square inches. In another embodiment, the size of a sheet is in the range of between about 16 square inches and 144 square inches. In yet another embodiment, the size of the sheet is about 36 square inches.

Hereinafter this disclosure will refer to a sheet as either an “absorbent sheet” or a “wood finishing sheet” depending on the phase of preparation that the apparatus is in. The term “absorbent sheet” refers to a dry fiber, fabric or tissue that is capable of taking in or absorbing a liquid, and the term “wood finishing sheet” refers to the same material once it has been fully permeated with a liquid. An example of an absorbent sheet capable of use in the present disclosure is a Scott® Shop Towel manufactured by Kimberly Clark.

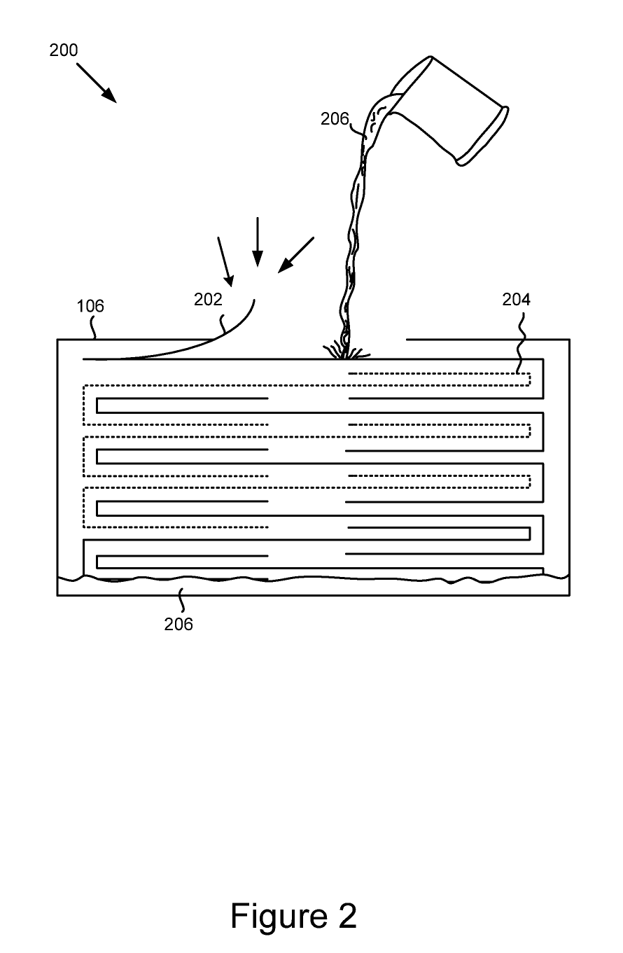

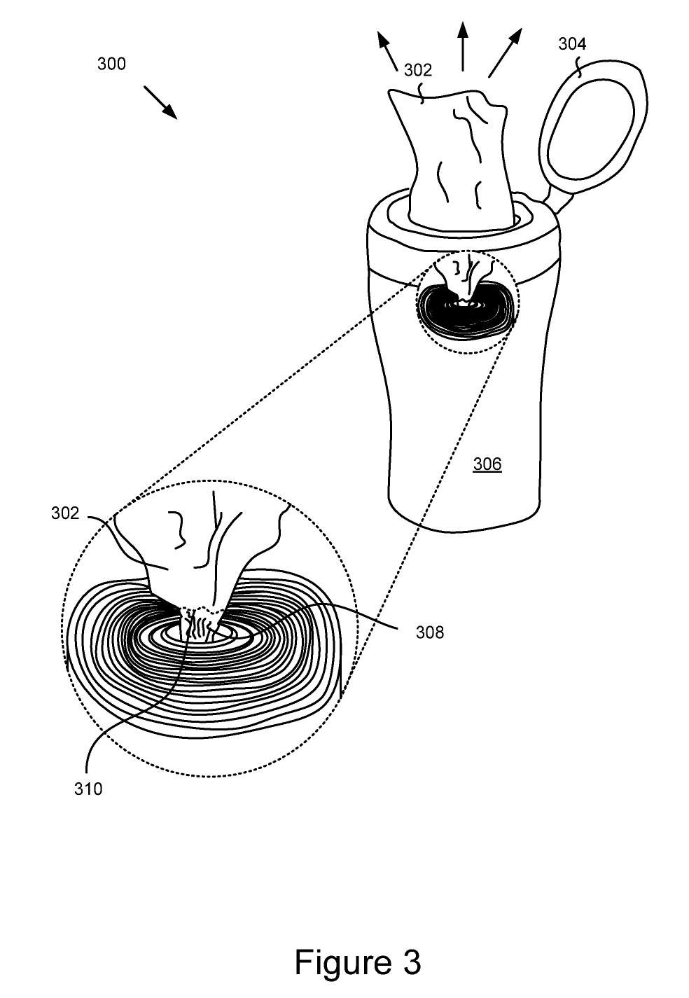

A suitable container 106 may be rigid or flexible and may be constructed from polymer fibers, plastic, glass, or cellulose fiber that is capable of holding a liquid inside. The sealing mechanism 104 may be a similar material that forms a flap which is capable of covering the opening in a container 106. The flap, acting as a lid for the container, may include an adhesive or an interlocking tab around the edge so as to allow the user to open and re-seal the container multiple times. The sealing mechanism 104 permits the sheets to stay moist by preventing the liquid from evaporating. The container 106 will be described in greater detail below with reference to FIGS. 2 and 3.

FIG. 2 is a cross-sectional diagram 200 depicting one embodiment of the preparation of a wood finishing sheets apparatus 100. The cross-sectional view 200 illustrates one embodiment of a packing arrangement of absorbent sheets within a container 106. The alternating orientation of the absorbent sheets allows the user, upon removal of the top sheet 202, to easily access the next-in-line sheet 204. FIG. 2 also shows a wood finishing composition 206 being added to the container 106.

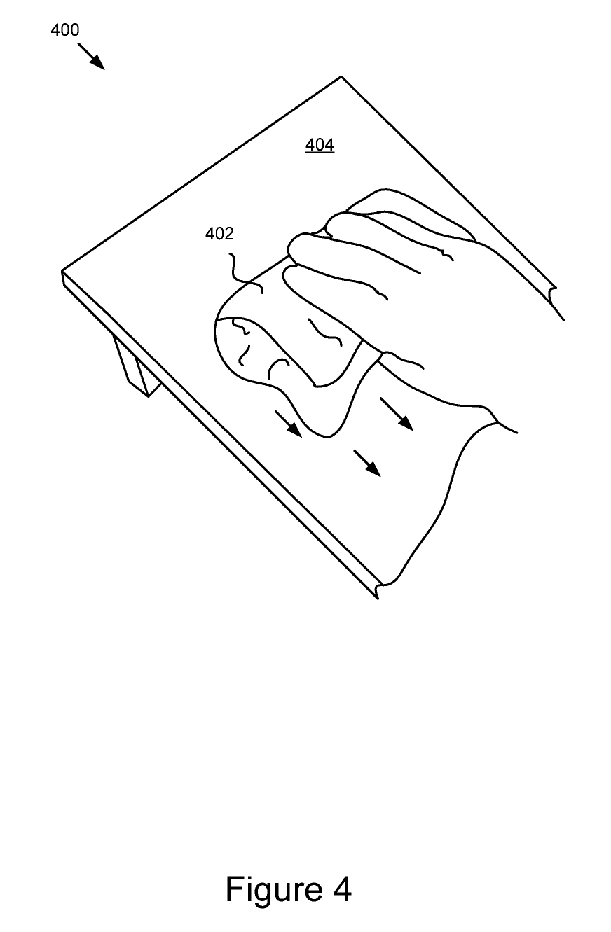

The wood finishing composition 206 may be any liquid that a person with an ordinary level of skill in the art would recognize as being capable of use in the treatment, protection and finishing of wood surfaces. For example, wood stain, colored finish, clear-coat, and wood sealant may be used as wood finishing compositions in the present disclosure. In one embodiment, the wood finishing composition may also include an extender chemical. The extender chemical provides the user with more time to apply the wood finishing composition to a desired wood surface before it dries. The increased work-time may help users achieve a more consistent and uniform application. One example of an extender chemical capable of use in the present disclosure includes, but is not limited to, diethylene glycol monoethyl ether. In one embodiment, the volume percentage of the extender chemical added to the wood finishing composition is in the range of between about 0.1% and 3.0%. In another embodiment, the range is between about 0.5% and 1.5%. In yet another embodiment, the volume percentage of extender chemical in the wood finishing composition is about 0.75%. The extender chemical will be described in greater detail below with reference to FIG. 4.

The depicted volume of liquid wood finishing composition 206 in FIG. 2 is not necessarily representative of the actual amount that may be added to the container. Once the wood finishing composition 206 has been added, the container 106 may be sealed and the wood finishing composition 206 may permeate the absorbent sheets. In one embodiment, the preparation method may further include a step in which the container is systematically agitated or rotated in order to facilitate uniform permeation among all the sheets.

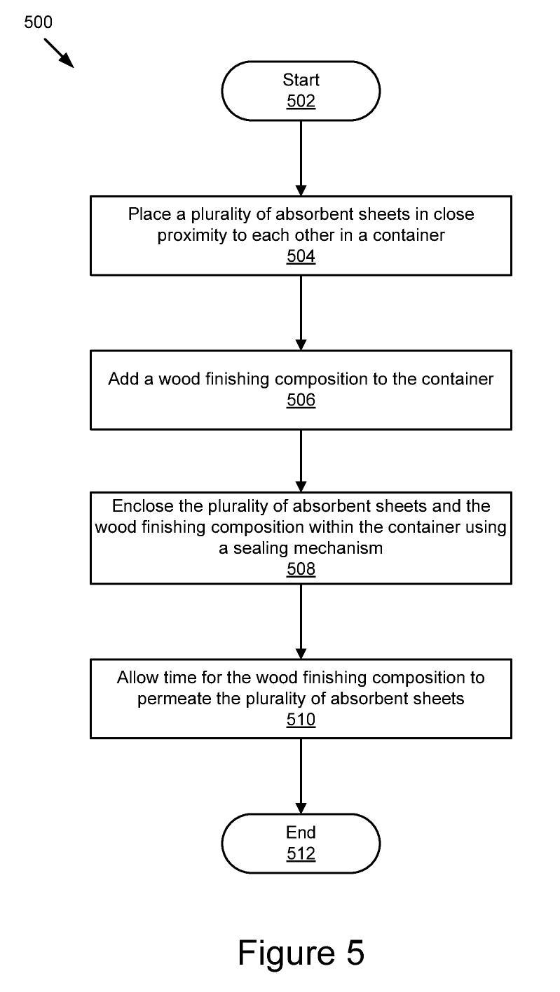

The interior volume of the container and the amount of wood finishing composition is selected according to the mass and dimensions of the absorbent sheets in order for the wood finishing composition to be substantially absorbed by the sheets. For example, a quart size container may hold about 55 absorbent sheets, each sized at about 36 square inches, and about 16 ounces of wood finishing composition. Further details regarding packing arrangements will be discussed below in reference to FIG. 5.

FIG. 3 illustrates another embodiment of an apparatus 300 which is used for preparing, containing, and dispensing wood finishing sheets. The figure depicts a container 306 with a sealing mechanism 304 that has been opened and a wood finishing sheet 302 that has been partially removed. A suitable container may be constructed from a polymer or cellulose fiber that is capable of holding a liquid inside. The sealing mechanism may be a similar material that forms a flap which is capable of covering the opening in the container.

Also depicted is a cut-away view of the packing arrangement of the wood finishing sheets inside the container 306. The fiber, fabric or tissue that makes up the sheets may be perforated in order to distinguish the individual sheets. The material may be rolled so as to fit within a cylindrical container 306. The first wood finishing sheet 302 is distinguished from subsequent wood finishing sheets 308 by the line of perforation 310 which allows the wood finishing sheets to be separated from one another and individually removed from the container 306. The first sheet may be pulled from the center of the role (as depicted) or it may be pulled from the outside of the roll. During the preparation of the apparatus 300, the role of sheets may be packed so as to allow the absorbent sheets to wick the wood finishing composition up through the center of the roll. It is contemplated that other containers may also be used.

FIG. 4 illustrates one embodiment of using a wood finishing sheet. Upon removing a single wood finishing sheet 402 from a container and orienting the sheet in the user's hand, the user wipes the wood finishing sheet 402 along the grains of a wood surface 404. The user may make multiple passes with the wood finishing sheet 402 over the same area of the wood surface 404 to increase the amount of wood finishing composition that is applied to the wood surface 404 and to promote a smooth and continuous application.

The wood finishing composition dries within 15 minutes, in one example, and the user may choose to apply subsequent coats. If the extender chemical is added to the wood finishing composition, the drying process may take up to 30 minutes but the user will have more working time to spread the wood finishing composition evenly and continuously over a wood surface 404.

FIG. 5 is a schematic flow chart diagram illustrating one embodiment of a method 500 for preparing wood finishing sheets. The method 500 starts 502 and a plurality of absorbent sheets are placed 504 within close proximity to each other. As depicted in FIG. 2, the absorbent sheets may be stacked in a container with each sheet having flaps that interlay with the sheet above and below. Such a packing arrangement allows the user, upon removal of the first sheet, to easily have access to the next-in-line-sheet. Alternatively, the absorbent sheets may be packed in a manner as described above with reference to FIG. 3. In other words, the sheet material may be perforated and then rolled up so as to fit into a cylindrical container.

As described above, the volume of the container is selected according to the mass and dimensions of the sheets and the amount of wood finishing composition added to the container. In other words, substantially complete absorption of the wood finishing composition is achieved when the volume of the container is selected according to the mass and dimensions of the sheets. For example, substantially complete absorption of the wood finishing composition is achieved with a length of fabric material perforated to distinguish about 55 absorbent sheets, each sized at about 36 square inches, and rolled and placed within a quart sized cylindrical container. This is only one example and many other masses, dimensions, and container volumes may be selected while still achieving substantially complete absorption of the wood finishing composition.

The wood finishing composition is then added 506 to the container. Continuing from the previous example, after the perforated roll has been added to the container, about 16 ounces of wood finishing composition may be added to the container. In other words, about 0.3 ounces per 36 square inch sheet is added to the container. The method 500 continues and the sealing mechanism encloses 508 the absorbent sheets and the wood finishing composition within the container. The wood finishing composition is then allowed time 510 to permeate the absorbent sheets. In one example, the time required to permeate the absorbent sheets is in the range of between about 5 and 20 minutes. After the absorbent sheets have absorbed all of the wood finishing composition they are referred to as wood finishing sheets and the method ends 512.

If the extender chemical is added to the wood finishing composition, the method 500 may require an additional step in which the extender chemical is mixed with the wood finishing composition before adding 506 it to the container. Also, in order to help the wood finishing composition evenly permeate the absorbent sheets, an agitation step may be added to the method. Such a step would augment permeation by systematically rotating or shaking the sealed container and would take place after the enclosure 508 step.

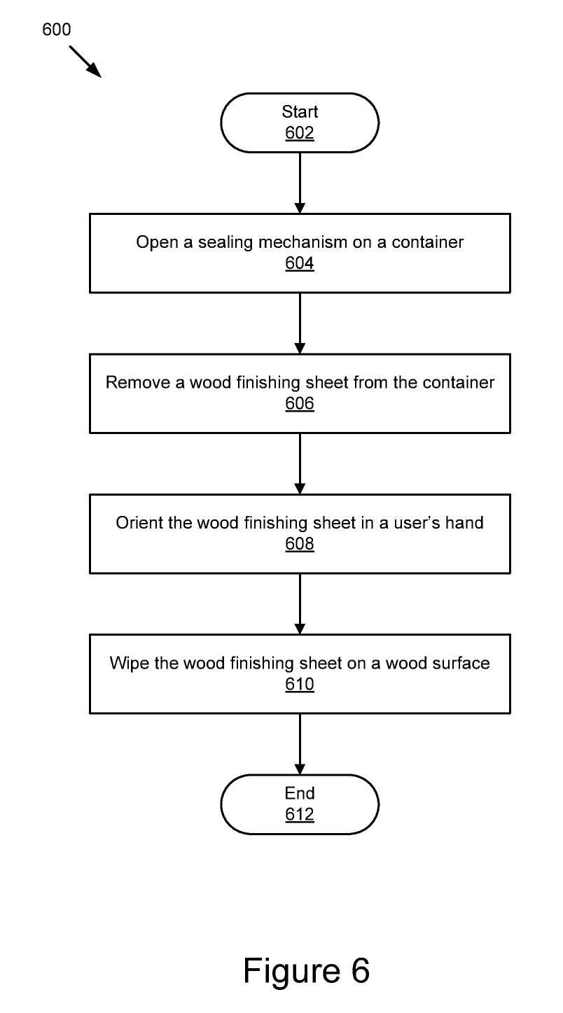

FIG. 6 is a schematic flow chart diagram illustrating one embodiment of a method 600 for using a single wood finishing sheet. The method starts 602 and a sealing mechanism is opened 604 on a container. For example, the sealing mechanism may be a flap that covers the opening of the container. Such a flap may have an interlocking tab that allows the user to open and re-seal the container. Once opened, a user may remove 606 a wood finishing sheet from the container and orient 608 the wood finishing sheet in his hand. For example, the user may choose to fold the sheet in half or flatten the sheet across both hands in preparation for application.

It is contemplated that the user may re-seal the container after removing a single sheet in order to prevent the wood finishing composition from evaporating. The user may then wipe 610 the wood finishing sheet along the grains of a wood surface and the method ends 612. The user may wipe the same area several times, apply varying amounts of pressure and/or re-orient the sheet in his hand in order to achieve a continuous and smooth application. The method may be repeated multiple times in order to apply a desired amount of wood finishing composition over a desired wood surface.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. An apparatus comprising:
a plurality of absorbent sheets in close proximity to each other in a container; and
a wood finishing composition being evenly permeated throughout the plurality of absorbent sheets.

2. The apparatus of claim 1, wherein the wood finishing composition is selected from a group consisting of stain, colored finish, clear coat, and wood sealant.

3. The apparatus of claim 1, wherein the wood finishing composition further comprises an extender chemical for increasing the time a user has to apply the wood finishing composition.

4. The apparatus of claim 3, wherein the extender chemical comprises a volume percentage of the wood finishing composition in the range of between about 0.1% by volume and 3.0% by volume.

5. The apparatus of claim 3, wherein the extender chemical comprises a volume percentage of the wood finishing composition in the range of between about 0.5% by volume and 1.5% by volume.

6. The apparatus of claim 3, wherein the extender chemical comprises a volume percentage of the wood finishing composition that is about 0.75% by volume.

7. The apparatus of claim 1, wherein the absorbent sheets are interconnected.

8. The apparatus of claim 1, wherein the number of absorbent sheets is in the range of between about 10 and 100.

9. The apparatus of claim 1, further comprising a sealing mechanism for allowing the container to be sealed and resealed multiple times.

10. A method for preparing wood finishing sheets, the method comprising:
placing a plurality of absorbent sheets in close proximity to each other in a container;
adding a wood finishing composition to the plurality of absorbent sheets;
enclosing within the container the plurality of absorbent sheets and the wood finishing composition using a sealing mechanism; and
allowing time for the wood finishing composition to permeate the plurality of absorbent sheets.

11. The method of claim 10, further comprising augmenting the permeation by systematically agitating the container.

12. The method of claim 10, wherein the wood finishing composition further comprises an extender chemical.

13. The method of claim 12, wherein the extender chemical comprises a volume percentage of the wood finishing composition in the range of between about 0.1% by volume and 3.0% by volume.

14. The method of claim 12, wherein the extender chemical comprises a volume percentage of the wood finishing composition in the range of between about 0.5% by volume and 1.5% by volume.

15. The method of claim 12, wherein the extender chemical comprises a volume percentage of the wood finishing composition that is about 0.75% by volume.

16. A method for using wood finishing sheets, the method comprising:
opening a sealing mechanism on a container;
removing a wood finishing sheet from the container;
orienting the wood finishing sheet in a user's hand; and
wiping the wood finishing sheet along a wood surface.

17. The method of claim 9, further comprising preparing a surface to be finished.
